(19) United States
(12) Patent Application Publication
(10) Pub. No.: US 2010/0110851 A1
(43) Pub. Date: May 6, 2010

(54) MULTILAYER-OPTICAL-DISC DATA-ERASURE METHOD AND OPTICAL DISC APPARATUS

(76) Inventor: Shohei AOYAMA, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/575,626

(22) Filed: Oct. 8, 2009

(30) Foreign Application Priority Data
Oct. 10, 2008 (JP) 2008-263436

(51) Int. Cl. G11B 20/18; G11B 27/00

(52) U.S. Cl. 369/53.2; 369/83; G9B/20.046; G9B/27

(57) ABSTRACT

An optical-disc testing apparatus performs test erasures on the test areas T of data layers of an optical disc while changing the power level Pe of data erasure laser light and the defocus amount if of the data erasure laser light from a target data layer. The optical-disc testing apparatus determines an optimal erasure condition that enables a simultaneous data erasure from the greatest number of data layers and an optimal erasure sequence that enables data erasure from all of the data layers with the fewest number of times. The determined optimal erasure condition and sequence are registered on the memory of an optical disc apparatus. The optical disc apparatus reads the registered optimal erasure condition and sequence of the optical disc from its memory and erases data from each of the data layers of the optical disc based on the read optimal erasure condition and sequence.

### CLAIM OF PRIORITY

The present application claims priority from Japanese patent application serial No. JP2008-263436, filed on Oct. 10, 2008, the content of which is hereby incorporated by reference into this application.

### BACKGROUND OF THE INVENTION

(1) Field of the Invention

The present invention relates to a data erasure method for a multilayer optical disc having multiple data layers and to an optical disc apparatus.

(2) Description of the Related Art

For the purpose of increasing the storage capacity of optical discs, multilayer optical discs, which each have a laminate structure of multiple data layers, are now being developed. For example, Blu-ray discs (BD), which enable high-density recording, can now have a total storage capacity of up to 400 GB by having 16 data layers each with a storage capacity of 25 GB. Increasing the number of data layers of an optical disc necessitates consideration of how to secure writing/reading capabilities for farther (or deeper) data layers from the light-incident surface of the disc and how to erase data from multiple data layers efficiently. For example, when data is erased from one data layer at a time, the data erasure time increases in proportion to the number of data layers.

For the purpose of initializing (i.e., erasing all data from) a multilayer disc in substantially the same amount of time as in initialization of a single-layer disc, JP-A-9-91700 discloses methods for simultaneously performing initialization on all the data layers by simultaneously radiating laser light onto all the data layers. Disclosed as its light radiation means are multiple optical heads (and multiple objective lenses) that are provided for the respective data layers and each radiate light (see Embodiments 1, 2 and 3). Further disclosed as the light radiation means is a single optical head (and a single objective lens) that radiates light onto multiple data layers with its focal depth being increased (see Embodiment 4).

### SUMMARY OF THE INVENTION

In accordance with the methods of JP-A-9-91700, a multilayer optical disc can be initialized in substantially the same amount of time as in initialization of a single-layer disc. However, the configurations of its Embodiments 1, 2, and 3 require, as the light radiation means, the use of as many optical heads (and objective lens) as the number of data layers. Thus, as the number of data layers increases, the apparatus of JP-A-9-91700 becomes structurally complex, and its associated component costs also increase. The configuration of Embodiment 4, in contrast, involves the use of a single optical head (and a single objective lens). However, this configuration also has a drawback: even if the focal depth of the optical head is increased, the effective light radiation range of the optical head is limited. Because a multilayer optical disc has a limitation on the number of data layers that can be initialized simultaneously, the configuration of Embodiment 4 is more likely to result in data layers that cannot be initialized sufficiently as the number of data layers increases. If initialization is to be performed each time such data layers occur, this may result in a decrease in data erasure efficiency. The configuration of Embodiment 4 is also prone to a decrease in data writing/reading quality. When the focal depth of the optical head is increased, this makes it difficult to narrow the focal point of its laser light, which also degrades the data writing/reading quality of the apparatus, especially in the case of high-density recording on BDs.

In view of the above problems and in response to the trend toward the increase in the number of data layers of optical discs, an object of the invention is thus to provide a data erasure method and an optical disc apparatus that enable faster data erasures with a simpler configuration.

One aspect of the invention is a data erasure method for a multilayer optical disc having a plurality of data layers, the method comprising the steps of: providing an optical-disc testing apparatus and an optical disc apparatus having a memory; the optical-disc testing apparatus performing test erasures on test areas of the plurality of data layers of the optical disc by radiating data erasure laser light while changing test erasure conditions; determining an optimal erasure condition that enables a simultaneous data erasure from the greatest number of data layers based on the results of the test erasures; determining an optimal erasure sequence that enables data erasure from all of the plurality of data layers with the fewest number of times based on the determined optimal erasure condition; registering the optimal erasure condition and the optimal erasure sequence of the optical disc on the memory of the optical disc apparatus; the optical disc apparatus reading the registered optimal erasure condition and optimal erasure sequence from the memory; and erasing existing data from the plurality of data layers of the optical disc based on the read optimal erasure condition and optimal erasure sequence.

Preferably, as the above test erasure conditions, the power level of the data erasure laser light and the defocus amount of the data erasure laser light from a target data layer are changed.

Preferably, the above step of determining the optimal erasure condition based on the results of the test erasures comprises the steps of: writing dummy data in the test areas of the plurality of data layers from which data has been erased by one of the test erasures; reading the dummy data from the test areas and measuring the jitter or error rates of the read dummy data; and judging the effect of the one of the test erasures on a particular one of the plurality of data layers to be effective when the measured jitter or error rate of dummy data read from the particular one of the plurality of data layers is equal to or less than an acceptable value.

Another aspect of the invention is an optical disc apparatus that performs data writing, reading, and erasure on a multilayer optical disc having a plurality of data layers, the apparatus comprising: an optical head for radiating laser light onto the optical disc to perform data writing, reading, and erasure; a laser power setup unit for setting the power level of data erasure laser light radiated by the optical head; a defocus amount setup unit for setting a defocus amount for the optical head so that the focus position of the data erasure laser light is displaced from a target data layer by the defocus amount; a memory for registering an optimal erasure condition and an optimal erasure sequence of the optical disc; and a microcomputer for reading the registered optimal erasure condition and optimal erasure sequence of the optical disc from the memory and setting the read optimal erasure condition and optimal erasure sequence for the laser power setup unit and the defocus amount setup unit, respectively, wherein the optical disc apparatus erases existing data from the plurality of data layers of the optical disc based on the optimal erasure condition and optimal erasure sequence.

In accordance with the invention, data erasure from a multilayer optical disc can be performed in a small amount of time with a structurally simpler apparatus.

### BRIEF DESCRIPTION OF THE DRAWINGS

These and other features, objects, and advantages of the present invention will become more apparent from the following description when taken in conjunction with the accompanying drawings wherein:

FIG. 1 illustrates a data erasure method for a multilayer optical disc and an optical disc apparatus according to an embodiment of the invention;

FIGS. 2A and 2B are tables showing examples of test erasure conditions and test erasure judgments;

FIG. 3 is a flowchart illustrating a learning process according to the embodiment; and

FIG. 4 is a flowchart illustrating a data erasure process according to the embodiment.

### DETAILED DESCRIPTION OF THE EMBODIMENTS

A data erasure method according to an embodiment of the invention involves the steps of obtaining an optimal erasure condition for optimally erasing data from an optical disc and registering the optimal erasure condition on a memory of an optical disc apparatus (these steps are hereinafter referred to as a learning process). The data erasure method also includes the steps of the optical disc apparatus reading the optimal erasure condition of the optical disc when the optical disc is loaded into the optical disc apparatus and erasing data from the optical disc based on the optimal erasure condition (these steps are hereinafter referred to as an erasure process). More specifically, during the learning process, test erasures are performed on the test areas of the optical disc while erasure conditions are changed, thereby determining the optimal erasure condition that enables a simultaneous data erasure from the greatest number of data layers and an optimal erasure sequence that enables data erasure from all of the data layers with the minimum number of times. The determined optimal erasure condition and optimal erasure sequence are registered on the memory of the optical disc apparatus.

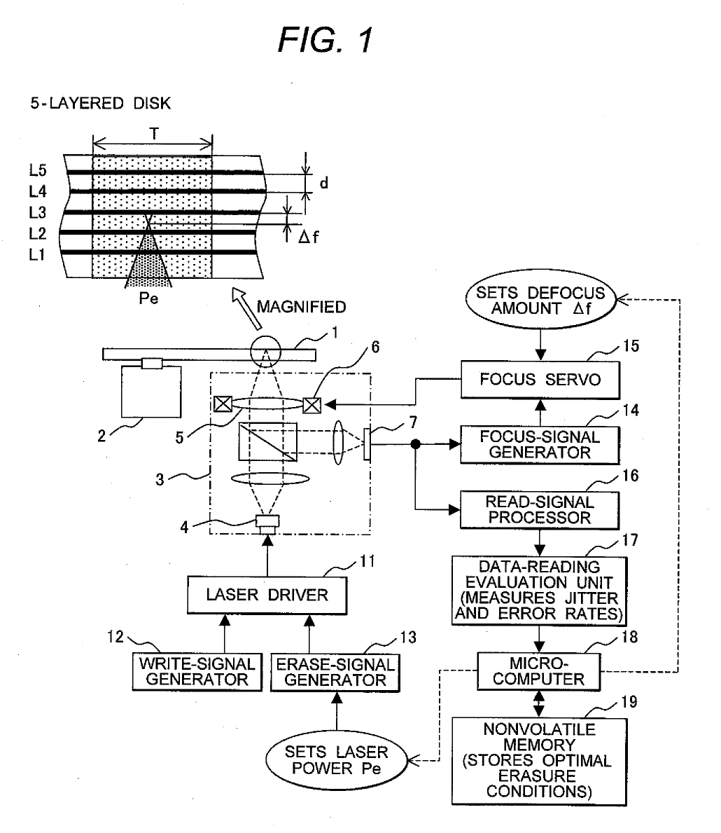

FIG. 1 illustrates the data erasure method for a multilayer optical disc and its associated optical disc apparatus according to the embodiment of the invention and is to explain both the learning process and the erasure process. Although, in practice, the learning process and the erasure process involve the use of an optical-disc testing apparatus and an end-user optical disc apparatus, respectively, FIG. 1 illustrates only one optical disc apparatus as the optical-disc testing apparatus or as the end-user optical disc apparatus for the sake of convenience because similar functions are shared by the two apparatuses.

### [Learning Process]

Because multilayer optical discs vary in the number of data layers, interlayer distance, the sensitivity of recording films, and the like, the optimal erasure condition (erase power and the like) that enables data erasure from multiple data layers with the fewest number of times and the optimal erasure sequence, that is, target data layers on which the focus of laser light is to be locked upon actual data erasure, are determined for each optical disc. This learning process is performed by an optical-disc testing apparatus, and the determined optimal erasure conditions and optimal erasure sequences are registered on the memory of an end-user optical disc apparatus before the end-user apparatus is shipped.

FIG. 1 shows an optical disc 1 to be tested, or a 5-layered rewritable disc. The data layers of the optical disc 1 are, from its laser-light-incident side, L1, L2, L3, L4, and L5, and the interlayer distances are each indicated by the letter ‘d.’ The following explanation is based on the assumption that each of the data layers holds data and that all the data is to be erased from all of the data layers. Note that the test areas T of the data layers are used for test erasures.

We now describe the optical-disc testing apparatus. By rotating the optical disc 1 with the use of a spindle motor 2 and radiating laser light onto the data layers with the use of an optical head 3, data is written on, read from, or erased from the optical disc 1. The optical head 3 includes a laser light source 4 that generate laser light with laser power Pe; an objective lens 5 that focuses the laser light on a particular data layer; an actuator 6 that moves the objective lens 5 in thickness directions of the optical disc 1 and in radially inward and outward directions of the optical disc 1; a photodetector 7 that detects light reflected from the optical disc 1 and converts the reflected light into an electrical signal; and the like. The objective lens 5 has a particular numerical aperture (NA), which value is set based on the format of the recording medium, or the optical disc 1. For example, the NA of a Blu-ray disc is typically set at 0.85 to ensure a small focal depth and hence high-density recording. The optical head 3 is moved by a sled motor (not illustrated) in a radially inward or outward direction of the optical disc 1 such that the optical head 3 faces a particular area (a particular radial position) of the optical disc 1. A laser driver 11 transmits a drive signal to the laser light source 4. A write-signal generator 12 generates a write signal based on a write strategy and also generates dummy data upon test erasure. An erase-signal generator 13 generates an erase signal that specifies a particular laser power level Pe.

A detection signal from the photodetector 7 is transmitted to a focus-signal generator 14 and to a read-signal processor 16. The focus-signal generator 14 generates a focus error (FE) signal from the detection signal. A focus servo 15 drives the actuator 6 to perform focus control. During the focus control, an offset is imparted to the focus servo 15 so that the focus position of laser light is displaced from the exact focus position on a target data layer by a particular amount. This displacement amount is herein referred to as a defocus amount Δf. Instead of imparting the offset, the defocus amount Δf can also be produced by changing the FE signal generated by the focus-signal generator 15. During test erasure, the defocus amount Δf and the laser power Pe of the laser light source 4 are used as its parameters to erase data from the test areas T of the data layers.

The read-signal processor 16 reads data from the detection signal received from the photodetector 7. A data-reading evaluation unit 17 evaluates the quality of the read data. More specifically, the data-reading evaluation unit 17 evaluates the quality of dummy data which is recorded after a test erasure by measuring the jitter or error rate of the dummy data read by the read-signal processor 16 and transmits the result to a microcomputer 18. When the measured jitter or error rate is equal to or less than an acceptable value, the microcomputer 18 judges the test erasure “effective.” If not, the microcomputer 18 judges the test erasure “not effective.” The judgment result of the test erasure is stored on a nonvolatile memory 19. Based on the test erasure judgment result, the microcomputer 18 also determines the optimal erasure condition (parameters) that enables a simultaneous data erasure from the greatest number of data layers. In addition, the microcomputer 18 determines, based on the optimal erasure condition determined, the optimal erasure sequence that enables data erasure from all of the data layers with the minimum number of times (the optimal erasure sequence can be paraphrased as target data layers on which focus servo control is to be performed). The determined optimal erasure condition and optimal erasure sequence are stored on the nonvolatile memory 19. In this manner, the optical-disc testing apparatus learns optimal erasure conditions and sequences on a disc-by-disc basis.

### [Erasure Process]

The optimal erasure condition and optimal erasure sequence of each optical disc acquired during the learning process are registered on a nonvolatile memory 19 of an end-user optical disc apparatus before the apparatus is shipped. The end-user optical disc apparatus is structurally almost the same as the optical-disc testing apparatus described above, and the erasure process with the use of the end-user optical disc apparatus is now described with continued reference to FIG. 1.

After the optical disc 1 from which to erase data is loaded into the end-user apparatus, the microcomputer 18 of the end-user apparatus reads the optimal erasure condition and optimal erasure sequence associated with the ID of the optical disc 1 from the nonvolatile memory 19 of the end-user apparatus. The data erasure laser power Pe and defocus amount Δf specified by the optimal erasure condition are then set for the erase-signal generator 13 and the focus servo 15, respectively, of the end-user apparatus. Thereafter, data is erased from the optical disc 1 with focus servo control being performed on the target data layers Lf specified by the optimal erasure sequence. Thus, data can be erased from all the data layers of the loaded optical disc 1 with the minimum number of times.

The optical disc apparatus of this embodiment as the end-user optical disc apparatus or as the optical-disc testing apparatus is structurally simple in that it has a single optical head 3 and a single objective lens 5 and can also be applied to multilayer discs whose data layers are more than five. Further, since the focal depth of laser light is set small enough, the data writing/reading capabilities of the optical disc apparatus are not affected by the focal depth.

The learning process is discussed below further in detail.

During test erasure, test erasure laser light is radiated onto the test areas T of the data layers of the optical disc 1, thereby determining the number of data layers from which data can be erased simultaneously. In this case, by locking the focus of the laser light onto a middle layer (the third layer L3 in the case of the 5-layered optical disc 1), test erasure results can be obtained for both of the upper layers above and the lower layers below the middle layer. The test areas T of the data layers are, in this case, data areas of several blocks and located at the same radial position of the optical disc 1. The test erasure is repeated for as many test erasure conditions as there are. Each time the test erasure is performed, different test areas T or the same test areas T can be used.

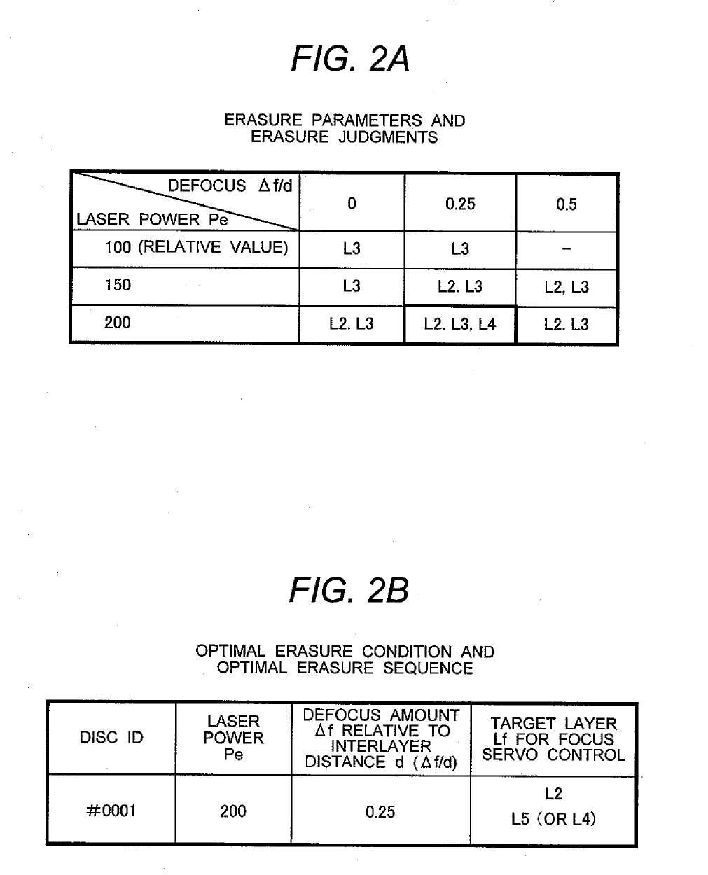

FIGS. 2A and 2B are tables showing examples of test erasure conditions and test erasure judgments. More specifically, FIG. 2A shows test erasure parameters and test erasure judgments, and FIG. 2B shows the optimal erasure condition and optimal erasure sequence.

As shown in the example of FIG. 2A, the parameters used upon test erasure are DC (direct-current) erase laser powers Pe of 100, 150, and 200 (relative values) and defocus amounts Δf relative to the interlayer distance d, i.e., Δf/d of 0, 0.25, and 0.5. Those two kinds of parameter sets are combined to examine the optimal combination, i.e., the optimal erasure condition.

After a test erasure is performed with the use of one set of a laser power value Pe and a defocus amount Δf, the erasure effect on each data layer is judged. To judge the erasure effect, dummy data is first recorded in the test areas T from which data has been erased by the test erasure. The dummy data can be data having a particular pattern or randomly created data as in optimum power control (OPC). The recorded dummy data is then read, and its quality is evaluated. More specifically, the data-reading evaluation unit 17 measures the jitter or error rate of the dummy data read. When the measurement value is equal to or less than an acceptable value, the test erasure can be judged “effective.”

The table of FIG. 2A shows all parameter combinations, and their results each show a data layer(s) in which test erasure was judged “effective.” For example, when Pe=100 and Δf/d=0, only the data layer L3 was judged as “erasure effective.” When Pe=200 and Δf/d=0.25, on the other hand, the data layers L2, L3, and L4 were judged as “erasure effective.” Accordingly, the optimal erasure condition that enables a simultaneous data erasure from the greatest number of data layers is when Pe=200 and Δf/d=0.25, as shown in FIG. 2B. In this case, the maximum number (N) of data layers from which data can be erased simultaneously is three. In order to erase data from the all the data layers with the minimum number of times based on the above optimal erasure condition, data is first erased from the data layers L1, L2, and L3 by setting the data layer L2 as a first target layer Lf on which focus servo control is to be performed. Data is erased next from the data layers L4 and L5 by setting the data layer L4 or L5 as a second target layer Lf on which focus servo control is to be performed next. The above sequence is determined as the optimal erasure sequence. The optimal erasure condition and optimal erasure sequence are stored on the nonvolatile memory 19 of the optical-disc testing apparatus together with the ID (#0001) of the optical disc 1.

Optimal erasure conditions and optimal erasure sequences stored on the nonvolatile memory 19 of the optical-disc testing apparatus on a disc-by-disc basis, as shown in FIG. 2B, are later registered on the nonvolatile memory 19 of the end-user optical disc apparatus. The end-user optical disc apparatus performs data erasure based on the optimal erasure conditions and optimal erasure sequences registered on its nonvolatile memory 19.

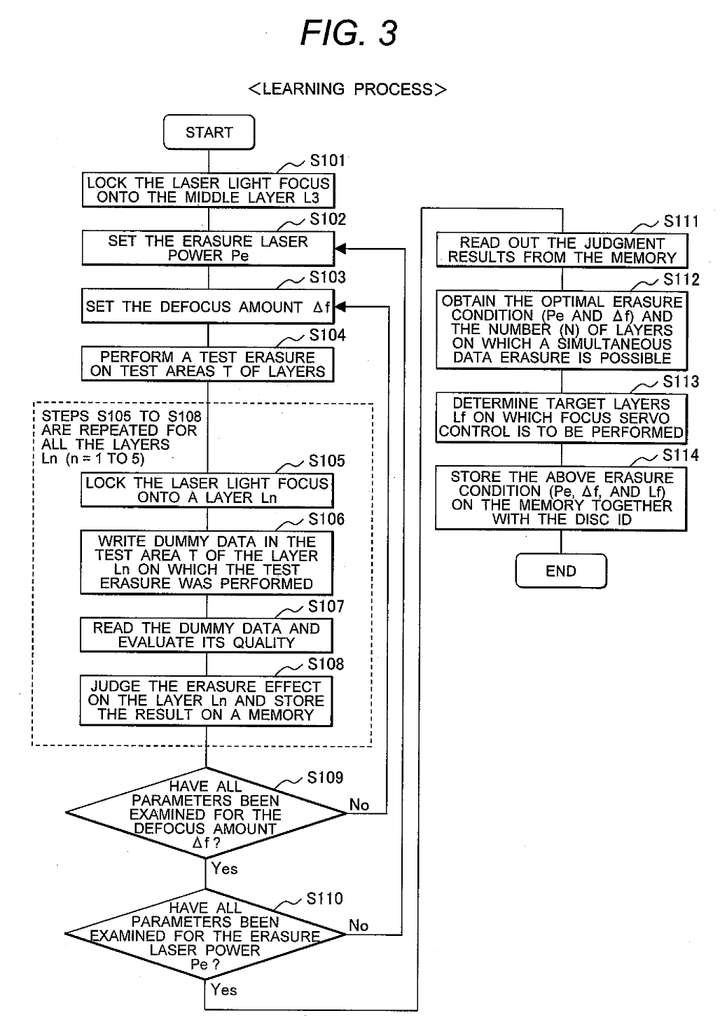

FIG. 3 is a flowchart illustrating the learning process of the thus-far described embodiment, which process is applied to the 5-layered optical disc 1 as in FIGS. 1, 2A, and 2B. The following process flow is controlled by the microcomputer 18 of the optical-disc testing apparatus based on a program.

In Step S101, focus servo control is performed on the middle data layer L3 of the optical disc 1 to be tested.

In Step S102, the test erasure laser power Pe of the optical head 3 is set at, for example, a relative value of 100, which is one of the predetermined test erasure parameters.

In Step S103, the defocus amount Δf for the focus servo 15 is set at one of the predetermined test erasure parameters (for example, Δf/d=0).

In Step S104, the optical head 3 is moved to face the test areas T of the data layers, and a test erasure is performed on the test areas T with the use of the above two parameters.

Steps 5105 to S108 are performed to judge the test erasure effects on the respective data layers Ln (n=1 to 5).

In Step 5105, focus servo control is performed on a data layer Ln.

In Step S106, dummy data is written on the test area T of the data layer Ln from which data has been erased by the test erasure.

In Step S107, the dummy data is read, and its quality is evaluated. More specifically, the jitter or error rate of the read dummy data is measured.

In Step S108, if the evaluated quality is within an acceptable range, the test erasure is judged “effective,” and the result is stored on the nonvolatile memory 19 of the optical-disc testing apparatus. Thereafter, the process returns to Step S105 to judge the test erasure effect on another data layer Ln.

Step S109 is to judge whether all the parameters have been examined for the defocus amount Δf. If not, the process returns to Step 5103 to set the defocus amount Δf at another value.

Step S110 is to judge whether all the parameters have been examined for the test erasure laser power Pe. If not, the process returns to Step 5102 to set the laser power Pe at another value.

Step 5111 is to read from the nonvolatile memory 19 the test erasure judgment results obtained with all the sets of parameters.

Step S112 is to obtain the optimal erasure condition (Pe and Δf) that enables a simultaneous data erasure from the greatest number of data layers and the maximum number (N) of data layers from which data can be erased simultaneously. In the examples of FIGS. 2A and 2B, Pe=200, Δf/d=0.25, and N=3.

Step 5113 is to determine target data layers Lf on which focus servo control is to be performed as the optimal erasure sequence that enables data erasure from all of the data layers with the minimum number of times. In the examples of FIGS. 2A and 2B, Lf=L2 and either L5 or L4.

In Step S114, the optimal erasure condition and optimal erasure sequence (Pe, Δf, and Lf) are stored on the nonvolatile memory 19 of the optical-disc testing apparatus together with the ID of the optical disc 1.

In this manner, optimal erasure conditions and optimal erasure sequences are determined on a disc-by-disc basis and later registered on the nonvolatile memory 19 of the end-user optical disc apparatus.

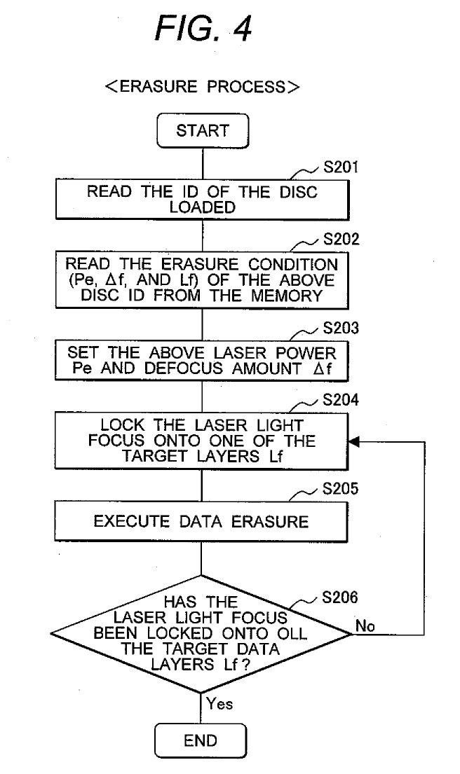

FIG. 4 is a flowchart illustrating the erasure process of the thus-far described embodiment. The following process flow is controlled by the microcomputer 18 of the end-user optical disc apparatus based on a program.

In Step S201, the end-user apparatus reads the ID of the loaded optical disc 1 from the information management area of the optical disc 1.

In Step S202, the end-user apparatus reads from its nonvolatile memory 19 the optimal erasure condition registered with the read disc ID (i.e., its data erasure laser power Pe, defocus amount Δf, and target data layers Lf on which focus servo control is to be performed).

In Step 5203, the end-user apparatus sets the read data erasure laser power Pe (e.g., Pe=200 in the case of FIGS. 2A and 2B) and defocus amount Δf (e.g., Δf/d=0.25 in the case of FIGS. 2A and 2B) for the erase-signal generator 13 and the focus servo 15, respectively, of the end-user apparatus.

In Step S204, the end-user apparatus applies focus servo control to one of the target data layers Lf (e.g., Lf=L2 in the case of FIGS. 2A and 2B).

In Step S205, the end-user apparatus erases data from the optical disc 1 under the above conditions.

In Step 5206, the end-user apparatus judges whether there is any target data layer Lf left on which focus servo control is yet to be applied. If so, the process returns to Step S204, and focus servo control is performed on the next target data layer Lf. In the examples of FIGS. 2A and 2B, the second target data layer is the data layer L5 (or L4). When there is no target data layer Lf left, the end-user apparatus terminates the erasure process.

As stated above, the present embodiment is designed to perform a learning process (FIG. 3) and an erasure process (FIG. 4). In the learning process, test erasures are performed to determine the optimal erasure condition that enables a simultaneous data erasure from the greatest number of data layers and the optimal erasure sequence that enables data erasure from all of the data layers with the minimum number of times (i.e., target data layers on which focus servo control is to be performed). The optimal erasure condition and the optimal erasure sequence are registered on the memory of an end-user optical disc apparatus. In the erasure process, data erasure is performed based on the registered optimal erasure condition and optimal erasure sequence. Therefore, data erasure can be performed most efficiently in the least amount of time. Because the data erasure is based on the results of the test erasures, it is less prone to erasure failure and thus highly reliable.

The above-described embodiment can be applied not only to data erasure from all data layers but to data erasure from particular data layers. In that case, the target data layers on which focus servo control is to be performed should be changed appropriately.

When a data erasure condition for another type of optical disc needs to be newly added or when the already registered erasure conditions need to be modified after shipment of an end-user optical disc apparatus, the user is allowed to update the data registered on its nonvolatile memory 19 (firmware). It should further be noted that optimal erasure conditions and sequences can be stored on the information management area of the optical disc 1, instead of being stored on the nonvolatile memory 19 of the end-user optical disc apparatus, so that such information can be read therefrom.

The data erasure method of the above-described embodiment can also be applied to non-rewritable, write-once discs such as DVD-R. In that case, overwriting is performed on the existing data of such a disc with erase power. Thus, the existing data can be destroyed in a small amount of time.

While we have shown and described several embodiments in accordance with our invention, it should be understood that the disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A data erasure method for a multilayer optical disc having a plurality of data layers, the method comprising the steps of:
providing an optical-disc testing apparatus and an optical disc apparatus having a memory;
the optical-disc testing apparatus performing test erasures on test areas of the plurality of data layers of the optical disc by radiating data erasure laser light while changing test erasure conditions;
determining an optimal erasure condition that enables a simultaneous data erasure from the greatest number of data layers based on the results of the test erasures;
determining an optimal erasure sequence that enables data erasure from all of the plurality of data layers with the fewest number of times based on the determined optimal erasure condition;
registering the optimal erasure condition and the optimal erasure sequence of the optical disc on the memory of the optical disc apparatus;
the optical disc apparatus reading the registered optimal erasure condition and optimal erasure sequence from the memory; and
erasing existing data from the plurality of data layers of the optical disc based on the read optimal erasure condition and optimal erasure sequence.

2. The data erasure method for the multilayer optical disc defined in claim 1, wherein the power level of the data erasure laser light and the defocus amount of the data erasure laser light from a target data layer are changed as the test erasure conditions.

3. The data erasure method for the multilayer optical disc defined in claim 1, wherein the step of determining the optimal erasure condition based on the results of the test erasures comprises the steps of:
writing dummy data in the test areas of the plurality of data layers from which data has been erased by one of the test erasures;
reading the dummy data from the test areas and measuring the jitter or error rates of the read dummy data; and
judging the effect of the one of the test erasures on a particular one of the plurality of data layers to be effective when the measured jitter or error rate of dummy data read from the particular one of the plurality of data layers is equal to or less than an acceptable value.

4. An optical disc apparatus that performs data writing, reading, and erasure on a multilayer optical disc having a plurality of data layers, the apparatus comprising:
an optical head for radiating laser light onto the optical disc to perform data writing, reading, and erasure;
a laser power setup unit for setting the power level of data erasure laser light radiated by the optical head;
a defocus amount setup unit for setting a defocus amount for the optical head so that the focus position of the data erasure laser light is displaced from a target data layer by the defocus amount;
a memory for registering an optimal erasure condition and an optimal erasure sequence of the optical disc; and
a microcomputer for reading the registered optimal erasure condition and optimal erasure sequence of the optical disc from the memory and setting the read optimal erasure condition and optimal erasure sequence for the laser power setup unit and the defocus amount setup unit, respectively;
wherein the optical disc apparatus erases existing data from the plurality of data layers of the optical disc based on the optimal erasure condition and optimal erasure sequence.

5. An optical-disc testing apparatus that determines data erasure conditions of a multilayer optical disc having a plurality of data layers; the apparatus comprising:
an optical head for radiating laser light onto the optical disc to perform data writing, reading, and erasure;
a laser power setup unit for setting the power level of data erasure laser light radiated by the optical head;
a defocus amount setup unit for setting a defocus amount for the optical head so that the focus position of the data erasure laser light is displaced from a target data layer by the defocus amount;
a data-reading evaluation unit for evaluating the quality of data read from the optical disc;
a microcomputer for instructing the optical head to perform test erasures on test areas of the plurality of data layers of the optical disc under various test erasure conditions and determining, based on the results of the test erasures, an optimal erasure condition that enables a simultaneous data erasure from the greatest number of data layers and an optimal erasure sequence that enables data erasure from all of the plurality of data layers with the fewest number of times; and
a memory for storing the determined optimal erasure condition and optimal erasure sequence;
wherein: the microcomputer instructs the optical head to perform the test erasures while instructing the laser power setup unit to change the power level of the data erasure laser light and the defocus amount setup unit to change the defocus amount;
the microcomputer instructs the optical head to write dummy data in the test areas of the plurality of data layers from which data has been erased by one of the test erasures;
the microcomputer instructs the data-reading evaluation unit to measure the jitter or error rates of the dummy data read from the test areas by the optical head;
the microcomputer judges the effect of the one of the test erasures on a particular one of the plurality of data layers to be effective when the measured jitter or error rate of dummy data read from the particular one of the plurality of data layers is equal to or less than an acceptable value; and
the microcomputer determines, based on the results of the test erasures, the optimal erasure condition and the optimal erasure sequence.
